(19) United States
(12) Patent Application Publication
(10) Pub. No.: US 2014/0135080 A1
(43) Pub. Date: May 15, 2014

(54) Cellular Telephone Case

(71) Applicants: Ed Kimball, Rockland, MA (US); Steven Kimball, Whitman, MA (US)

(72) Inventors: Ed Kimball, Rockland, MA (US); Steven Kimball, Whitman, MA (US)

(21) Appl. No.: 13/675,745

(22) Filed: Nov. 13, 2012

(51) Int. Cl. H04M 1/04

(52) U.S. Cl. CPC H04M 1/04
USPC 455/575.1

(57) ABSTRACT

A case for a cellular telephone is provided. The case is configured to receive and/or conceal a condom as well as the cellular telephone. In some embodiments, the condom may be used as added padding to protect the cellular telephone.

### BACKGROUND OF THE INVENTION

1. Field of the Invention

The present invention relates generally to a cellular telephone case. More particularly the present invention relates to a cellular telephone case that may store and/or conceal a condom, and that may use the condom for added padding.

2. Description of Related Art

Condoms are important prophylactic items that prevent both unexpected pregnancies, and the spread of sexually transmitted diseases. Often, men and women carry condoms around with them so that they may be prepared for sexual encounters, both expected and unexpected. One issue with condom transportation is that condoms can be cumbersome to store securely. Condoms can be easily lost if stored unsecured in a pocket or purse. Moreover, when stored in a place such as a wallet, it can be obvious that a condom is stored there, causing an unseemly appearance for the holder. Further still, as style becomes more streamlined and as wallets become more obsolete, a need exists for a convenient place to securely and subtly store condoms.

Therefore, what is needed is a cellular telephone case that may store a condom.

### SUMMARY OF THE INVENTION

The subject matter of this application may involve, in some cases, interrelated products, alternative solutions to a particular problem, and/or a plurality of different uses of a single system or article.

In one aspect, a cellular telephone case capable of holding a condom is provided. The case comprises a body, the body formed to receive a cellular telephone. The case further comprises a condom receiver, the condom receiver formed to receive a packaged condom. Thus, the cellular telephone may be positioned within the body, and a condom may be positioned within the condom receiver.

In another aspect, a cellular telephone case configured to use a packaged condom as padding is provided. The case comprises a body, the body formed to receive a cellular telephone. The case further comprises a condom receiver, the condom receiver formed to receive a packaged condom. The packaged condom, when positioned within the condom receiver is urged against the cellular telephone when the telephone is within the case, thereby acting as a padding between the case and the phone.

In yet another aspect, a method of using a condom as padding in a cellular telephone case is provided. The method comprises the steps of placing a condom within a condom receiver portion of the case, positioning the condom such that it may be in contact with a cellular telephone, and placing the cellular telephone in the case such that it contacts the condom. As such, the condom in contact with the telephone may act as a padding for the case.

### BRIEF DESCRIPTION OF THE DRAWINGS

FIG. 1 provides a perspective view of an embodiment of the cellular telephone case.

FIG. 2 provides a side view of an embodiment of the cellular telephone case.

FIG. 3 provides a rear view of an embodiment of the cellular telephone case.

FIG. 4 provides a bottom view of an embodiment of the cellular telephone case.

FIG. 5 provides a top view of an embodiment of the cellular telephone case.

FIG. 6 provides a side cutaway view of an embodiment of the cellular telephone case.

FIG. 7 provides a perspective view of an embodiment of the cellular telephone case.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a cellular telephone case configured to receive a condom. In some embodiments, the condom may provide padding to the telephone when both are positioned within the case.

The cellular telephone case may be formed out of any material capable of maintaining attachment to a cellular telephone, and providing a level of protection to the phone. In one embodiment, the case may be made out of a plastics material. In another embodiment, the case may be made out of a rubber material. In yet another embodiment, the case may be made out of a metal.

The case may be of any color or pattern desired by a user. Further, the case may be made of a transparent or translucent material, to allow the cellular telephone and condom to be viewable.

Generally, the term condom is used herein to refer to a rolled, packaged condom, but could additionally refer to a rolled condom removed from its package. Generally, the term cellular telephone is used to refer to mobile cellular telephone devices, however, the term cellular telephone may be used herein to also refer to any portable electronic device, including internet enabled mobile devices, iPods®, and the like.

The cellular telephone case contemplated herein generally comprises a body portion and a condom receiver portion. The body is formed such that an inner surface intended to contact the cellular telephone conforms to contact the telephone at nearly all positions. As such, a differently shaped telephone may require a differently shaped case. Further, the body may form one or a plurality of apertures allowing access to various ports and features of the phone. For example, a case body will have an aperture at a power port, headphone jack, and/or camera lens. In one embodiment, the cover may have a second, impact absorbing material disposed on its inner surface, providing protection in the case of a dropped phone. This impact absorbing material may be different from the case material.

In one embodiment, a rear face of the body may be substantially flat, save for the condom receiver positioned thereon. At peripheral edges of the rear face, a sidewall may protrude substantially perpendicularly from the face to envelop sides of the cellular phone. In further embodiments, a front edge of the sidewalls may extend inwardly towards a center of the rear face, allowing them to wrap partially over the cellular phone.

The body of the case may secure a cellular telephone in any manner. For example, the cellular telephone may be secured by a pressure fitting, a snap connection, by enveloping the cellular telephone fully or partially, among others.

The condom receiver may be any structure of the case capable of receiving and retaining a condom while in its wrapper. Preferably, the condom receiver may be sized to receive varying sized condom packages, such as standard sized condoms, large condoms and small condoms.

In one embodiment, the condom receiver may be a depression on an inner surface of the body. This depression may have a substantially square cross section to receive one or a plurality of condoms. In a further embodiment, the depression may have sloping edges leading to a flat receiving area.

In one embodiment, the depression may have a depth that is slightly shallower than the height of a condom. In this embodiment, a portion of the condom may protrude slightly from the depression. As such, when a cellular telephone is placed into the case, it is urged against the condom, allowing the flexible condom to act as a padding for the cellular telephone in the case.

The depression may protrude from a rear of the case body in some embodiments, or may be invisible from the rear of the case in other embodiments having a body thick enough to conceal the condom receiving depression. In one embodiment, the depression may be accessible from the rear of the case by, for example, a snap on cover, a hinged cover, a slide cover, or the like.

In another embodiment, the condom receiver may be a slot. The slot may be configured to slideably receive the condom. The slot may be built into a side of the case body to allow slideable access. In one embodiment, the slot may urge the condom upward and against a portion of the cellular telephone when held in the case. As such, when a cellular telephone is placed into the case, it is urged against the condom, allowing the condom to act as a padding for the cellular telephone in the case. In this embodiment, a door or other cover may operate to prevent the condom from sliding out of the case.

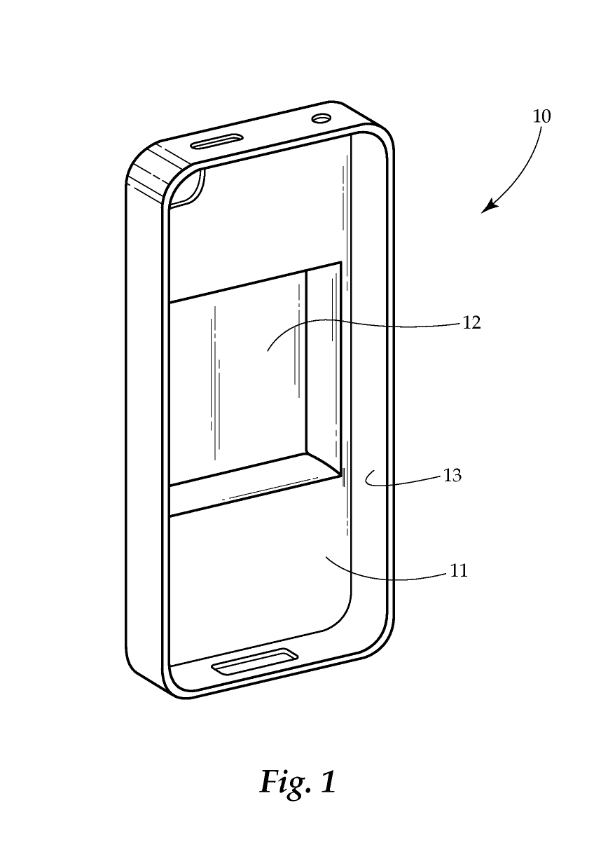

Turning now to FIG. 1, a perspective view of the case is provided. The case 10 is configured to receive both a cellular phone, as well as a condom. In this embodiment, the condom is stored in the condom receiver 12. The case body 11 forms the condom receiver 12. Sidewalls 13 extend from rear of the body 11 to envelop the cellular phone. In operation, a user may position a condom in the condom receiver 12, and then secure a cellular phone within the case 10. To remove the condom, the cellular phone must be removed as well. In one embodiment, the depth of the condom receiver 12 is slightly less than a height of the condom in its package. This construction allows the condom itself to function as a padding for the cellular phone when both condom and phone are within the case 10.

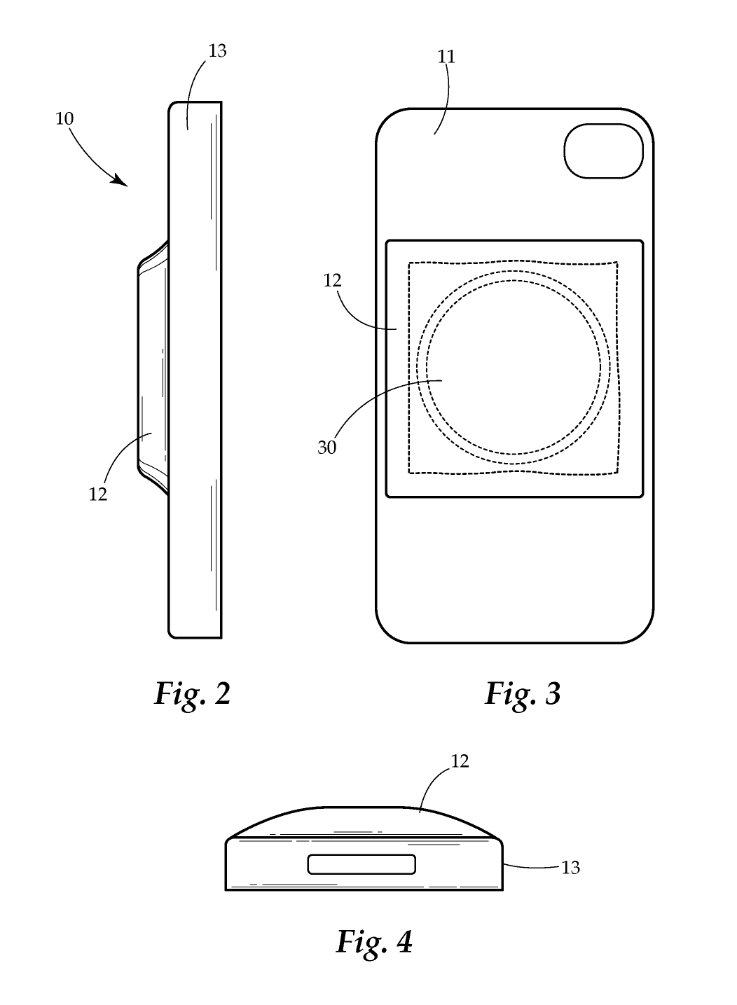

FIG. 2 shows a side view of an embodiment of the case 10. The sidewalls are configured to extend from the rear of the case 10 and envelop a phone placed within the case 10. The condom receiver 12 can be seen protruding from a rear of the case to accommodate for the condom.

FIG. 3 provides a rear view of an embodiment of the case 10 with a condom 30 placed therein. The rear of the case body 11 is seen as generally flat. Protruding from the rear 11 is the condom receiver 12. A condom 30 can be seen within the receiver 12.

FIG. 4 provides a bottom view of an embodiment of the case 10. The condom receiver 12 protrudes from the rear of the case 10. Sidewalls 13 extend to envelop the phone.

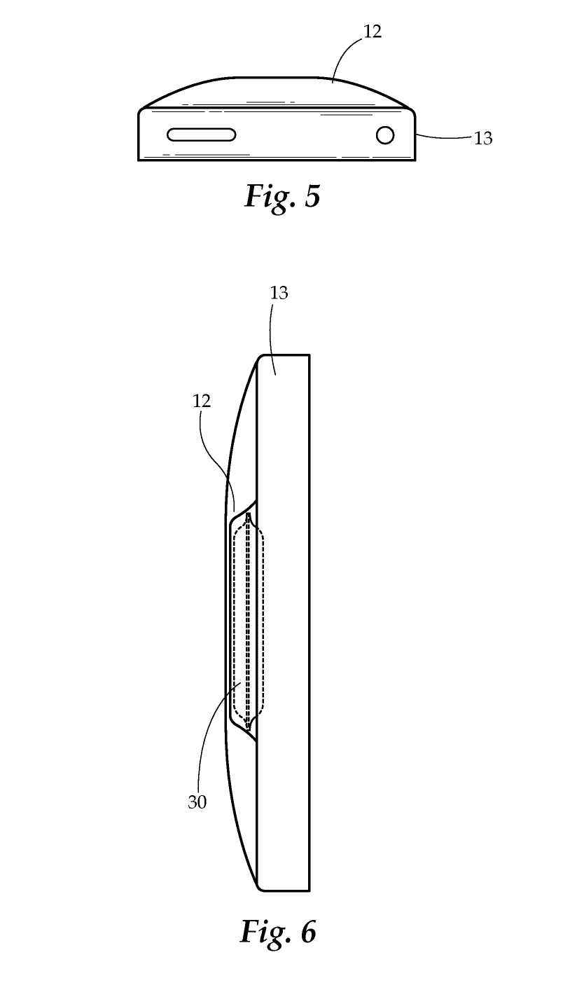

FIG. 5 provides a top view of an embodiment of the case. The condom receiver 12 protrudes from the rear of the case 10. Sidewalls 13 extend to envelop the phone.

FIG. 6 provides a side cutaway view of an embodiment of the case. In this embodiment, the sidewalls can be seen extending to envelop the phone. A condom 30 is positioned within the condom receiver 12. It can be seen that the depth of the condom receiver 12 is such that the condom 30 protrudes slightly above the rear face 11 of the case. As such, the condom 3 can be utilized for padding. FIG. 6 provides an embodiment wherein the condom receiver is not visible from a back of the case, as the rear of the case gradually becomes thinner as it reaches the edges, with no clear outline of the condom receiver 12. As such the protrusion caused by the condom receiver 12 is flush with a rear of the case. Additional advantages of this type of structure include added protection and durability because of the elliptical shape, an ease of sliding in and out of a user's pocket, ergonomic advantages, and ease of holding by a user.

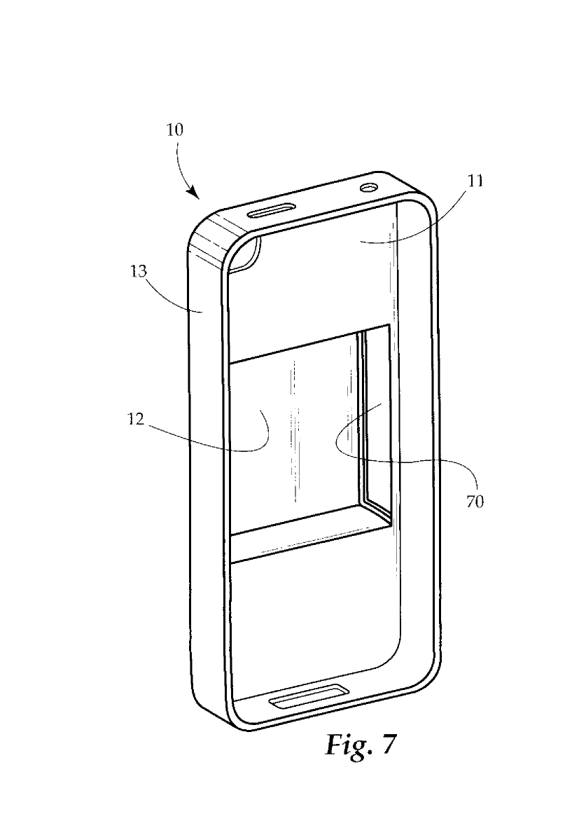

FIG. 7 provides a perspective view of the case 10. The case 10 is configured to receive both a cellular phone, as well as a condom. In this embodiment, the condom is stored in the condom receiver 12. The case body 11 forms the condom receiver 12. Sidewalls 13 extend from rear of the body 11 to envelop the cellular phone. A slot 70 is formed in a side of the condom receiver 12. The slot 70 is sized to allow a condom (not shown) to pass through and slide into the condom receiver 12. In one embodiment, the depth of the condom receiver 12 is slightly less than a height of the condom in its package. This construction allows the condom itself to function as a padding for the cellular phone when both condom and phone are within the case 10.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A cellular telephone case capable of holding a condom comprising:
a case, the case comprising:
a body, the body being formed to receive a cellular telephone;
a condom receiver, the condom receiver being formed to receive a packaged condom;
a cellular telephone positioned within the body;
a packaged condom, the packaged condom positioned within the condom receiver.

2. The cellular telephone case capable of holding a condom of claim 1 wherein the condom receiver is a depression on an inner surface of the case.

3. The cellular telephone case capable of holding a condom of claim 2 wherein a plurality of sides of the depression are sloped to a flat bottom of the depression, the flat bottom of the depression sized to receive the packaged condom.

4. The cellular telephone case capable of holding a condom of claim 2 wherein a depth of the depression is slightly shallower than a height of the packaged condom.

5. The cellular telephone case capable of holding a condom of claim 4 wherein the cellular telephone is urged against the packaged condom received within the condom receiver when the cellular telephone is positioned within the body.

6. The cellular telephone case capable of holding a condom of claim 1 wherein the condom receiver is a slot sized to slideably receive a packaged condom.

7. The cellular telephone case capable of holding a condom of claim 1 wherein the condom receiver is positioned behind the cellular telephone when positioned within the body, and wherein the condom within the condom receiver is accessible only when the cellular telephone is removed from the case.

8. The cellular telephone case capable of holding a condom of claim 1 wherein the condom within the condom receiver is accessible from an interior of the case and an exterior of the case.

9. A cellular telephone case having a packaged condom as padding comprising:
a case, the case comprising:
a body, the body being formed to receive a cellular telephone;
a condom receiver, the condom receiver being formed to receive a packaged condom;
a cellular telephone positioned within the body;
a packaged condom, the packaged condom positioned within the condom receiver, the condom receiver urging the condom against the cellular telephone, the condom acting as a padding between the case and the cellular telephone.

10. The cellular telephone case having a packaged condom as padding of claim 9 wherein the condom receiver is a depression in an inner surface of the case.

11. The cellular telephone case having a packaged condom as padding of claim 10 wherein a plurality of sides of the depression are sloped to a flat bottom of the depression, the flat bottom of the depression sized to receive the packaged condom.

12. The cellular telephone case having a packaged condom as padding of claim 10 wherein a depth of the depression is slightly shallower than a height of the packaged condom.

13. The cellular telephone case having a packaged condom as padding of claim 9 wherein the condom receiver is positioned behind the cellular telephone when positioned within the body, and wherein the condom within the condom receiver is accessible only when the cellular telephone is removed from the case.

14. The cellular telephone case having a packaged condom as padding of claim 9 wherein the condom within the condom receiver is accessible from an interior of the case and an exterior of the case.

15. A method of using a condom as a padding in a cellular telephone case comprising the steps of:
placing a condom into a condom receiver portion of a cellular telephone case having a body portion and the condom receiver portion;
positioning the condom, by the condom receiver portion, such that it may be in contact with a cellular telephone;
placing the cellular telephone within the case, the cellular telephone in contact with the condom, the condom acting as a padding between the cellular telephone and the case body.

16. The method of using a condom as a padding in a cellular telephone case of claim 15 wherein the step of placing a condom within the condom receiver portion comprises placing a condom within a depression on an inner surface of the case, the depression being the condom receiver portion, the depression having a depth slightly less than a height of the condom.

17. The method of using a condom as a padding in a cellular telephone case of claim 15 further comprising the steps of:
removing the cellular telephone from the case; and
removing the condom from the case after removing the cellular telephone.

18. The method of using a condom as a padding in a cellular telephone case of claim 15 wherein the step of placing a condom within the condom receiver portion comprises sliding the condom into a slot formed by the case, the slot being the condom receiving portion.

19. The method of using a condom as a padding in a cellular telephone case of claim 15 further comprising the step of removing the condom from a rear of the case.

20. The method of using a condom as a padding in a cellular telephone case of claim 15 further comprising the step of placing a plurality of condoms within the condom receiver portion.
